(19) United States
(12) Patent Application Publication
(10) Pub. No.: US 2006/0053403 A1
(43) Pub. Date: Mar. 9, 2006

(54) System and method for routing clock signals from a clock trunk

(76) Inventors: Christopher R. Cowan, Fort Collins, CO (US); C. Alva Barney, Fort Collins, CO (US); Aaron Eakin, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/936,991

(22) Filed: Sep. 9, 2004

(51) Int. Cl. G06F 17/50; G06F 1/04

(52) U.S. Cl. 716/13; 716/10; 713/500

(57) ABSTRACT

According to at least one embodiment, a system comprises a region generation engine operable to create a region automatically around a portion of a clock trunk in a block, wherein the region defines an area for placement of selected cells, an automatic cell placer operable to place the cells in the region, and a routing engine operable to route signal wires from the clock trunk to the cells automatically according to one or more functions.

### FIELD OF THE INVENTION

Various embodiments relate to circuit design in general, and more specifically, to tools to aid in the design of integrated circuits.

### DESCRIPTION OF RELATED ART

The design of an Integrated Circuit (IC) is a complex task, which often requires the work of many skilled people. One aspect of IC design is that paths for the various signals (data, power, clock, and the like) must be determined such that the logical elements of the IC may operate correctly.

One type of signal that may be required by some logical elements is a clock signal. A clock signal is usually a pattern of alternating high and low voltage levels at a certain defined frequency that is produced from fixed vibrations of a quartz crystal. In a microprocessor, the main clock usually defines the advertised speed of the device. For example, a 3.2 GHz microprocessor will usually employ a 3.2 GHz main clock. The clock signal may be used to synchronize various logical elements in the circuit to guarantee that data will be input and output by the elements in correct sequences. In most applications, computers with higher clock speeds provide more performance, although performance may also depend on a variety of other factors, such as internal cache design, software design, network speed, and disk speed.

In many designs it is important that clock signals be routed such that there are low levels of extraneous effects (such as interference) added to the clock signal. Traditional designs have offered various automatic and manual approaches for routing clock signals such that some level of extraneous effects is avoided; however, those approaches do not offer low levels of extraneous effects and time savings in the same system.

### BRIEF SUMMARY OF THE INVENTION

According to at least one embodiment, a system comprises a region generation engine operable to create a region automatically around a portion of a clock trunk in a block, wherein the region defines an area for placement of selected cells, an automatic cell placer operable to place the cells in the region, and a routing engine operable to route signal wires from the clock trunk to the cells automatically according to one or more functions.

### BRIEF DESCRIPTION OF THE DRAWINGS

FIG. 1 is an illustration of a system, adapted according to various embodiments, for routing clock signals in a block;

FIG. 2 is an illustration of a design, adapted according to various embodiments, for routing clock signals in a block;

FIG. 3 is an illustration of a design, adapted according to various embodiments, for routing clock signals in a block;

FIG. 4 is an illustration of a top level design for a microprocessor, according to various embodiments;

FIG. 5 is a flowchart depicting a method for routing clock signals in a block in a circuit design; and

FIG. 6 shows an example computer system adapted according to various embodiments.

### DETAILED DESCRIPTION

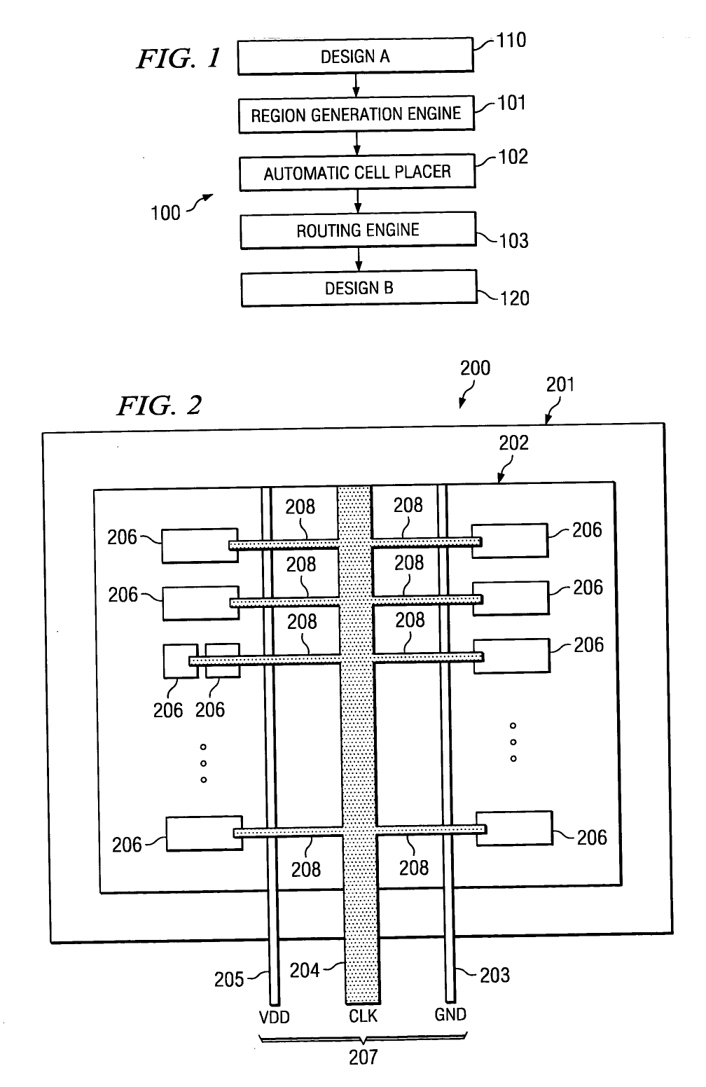

FIG. 1 is an illustration of system 100, adapted according to various embodiments, for routing clock signals in a block. System 100 includes region generation engine 101, which receives design 110 (with clock trunks routed in blocks), automatic cell placer 102, and routing engine 103, which outputs block design 120 (with clock signals routed to cells). Components 101-103 may, in some embodiments, be part of a larger, comprehensive circuit design tool (not shown) for use in designing integrated circuits, although they are shown by themselves in FIG. 1 for simplicity.

In this example, region generation engine 101 is operable to create a region automatically around a portion of a clock trunk in a block, wherein the region defines an area for placement of cells. A clock trunk is a piece of conducting material that is used to carry a clock signal to one or more cells. In one example, an integrated circuit may have three clocks (or “clock domains”)—one main clock, an inverted clock, and a test clock that runs at a lower frequency than the other two clocks and is used for testing parts of the circuit. A clock trunk is used to carry a signal from one of the clocks to a logical element (i.e., “cell”), as explained in more detail below. A block may be any logical subdivision of a circuit, as also explained in more detail below.

In this example, a clock trunk is routed into a portion of a block (or through a block, depending on the circuit) during the design process. Design 110, with clock trunks routed in a block, is input into region generation engine 101. As will be explained in more detail below, region generation engine 101 is operable to create a region automatically around a portion of the clock trunk in the block in design 110. The region defines an area for placement of cells because automatic cell placer 102 is programmed to place certain cells in the area provided by the region. In this example, the cells are selected to be in communication with a clock signal from the clock trunk, and may, therefore, be latches, flip-flops, or the like. Cells in communication with a clock signal may be referred to as “clocked” or “sequential” cells.

Routing engine 103 is then used to connect the cells with signals from the clock trunk by routing signal wires from the clock trunk to the elements automatically according to one or more functions. The functions may direct routing engine 103 to prefer some paths over others, as will be explained in more detail below. Routing engine outputs design 120, with clock signal wires routed to the cells. System 100 may be part of a larger, comprehensive Place and Route (P&R) tool that may perform functions other than those explicitly mentioned with regard to FIG. 1. For instance, a comprehensive P&R tool may also allow for the placement and routing of signals other than clock signals. Further, a P&R tool may provide a designer with many automatic features and may also assist the designer in manual tasks, such that various levels of automation are within the scope of various embodiments.

FIG. 2 is an illustration of design 200, adapted according to various embodiments, for routing clock signals in a block. Design 200 may be part of a design for a circuit, and it may be produced by components 101-103 of FIG. 2. Design 200 includes block 201, clock region 202, ground wire 203, clock trunk 204, power wire 205, latches 206, and clock signal wires 208. In this example, the power and ground wires 205 and 203, respectively, form a structure known as the power/ground rail, which is illustrated as item 207 in FIG. 2.

A block may be considered to be any kind of logical subdivision of a circuit. When viewing a circuit in its entirety, it may be said that a designer is viewing it at the “global level.” Below the global level is the top block level. For example, a microprocessor may include various areas devoted to one or more internal operations, such as a Floating Point Unit (FPU), an instruction fetch unit, an internal cache, or the like. Each unit may be considered to be a block. Moreover, units may be divided into one or more lower-level blocks, and those blocks may be further divided into other blocks, such that a given block may be one or more levels below the top block level. For instance, an FPU may be further divided into multiple floating point pipelines, which may each be further be divided into a floating point Arithmetic Logic Unit (ALU), a floating point load unit, and a floating point store unit. In short, a block may be any logical subdivision in a circuit lower than the global level, wherein the global level represents the circuit as a whole.

A block is usually served by one or more power/ground rails, such as rail 207. As the name implies, power/ground rail 207 supplies power to the components (i.e., cells) in block 201. In addition to power, some logical components in block 201 may also need to be in communication with a clock signal. Accordingly, in this embodiment, block 201 is served by clock trunk 204. As explained in more detail below, clock signals may be routed to sequential cells in block 201 from clock trunk 204.

Many cells in a block will require a clock signal with a minimum of interference. Phenomena, such as coupling capacitance, may cause electrical disturbances in clock signals, and if the disturbances are severe enough, the regular pattern of logical ones and zeroes in the signal may be degraded. Accordingly, this example design calls for routing clock trunk 204 between power wire 205 and ground wire 203 in power/ground rail 207. The placement of clock trunk 204 acts to shield it from inference from other sources because power/ground rail 207 lies between clock trunk 204 and other wires in the same plane (not shown).

In this example, power/ground rail 207 and clock trunk 204 are routed into block 201. In the case of clock trunk 204, this allows it to be spatially proximal to cells 206 of block 201, thereby allowing clock signals to be routed from clock trunk 204 to cells 206 with a minimum of distance. As mentioned above, cells 206 are a type of cell adapted to be in communication with a clock signal. In one example, cells 206 are latches, which are level sensitive. Such latches, for example, may read in a new value every time the clock signal is high (logical one). In other designs, cells 206 may be edge-triggered, thereby reading in a new value at each rising edge of the clock signal. Some designs may route a clock signal to one or more various types of sequential cells 206 other than latches, and those designs are within the scope of the embodiments.

In many designs, increasing a distance from a trunk to a cell leads to increasing delay as seen in the clock signal by the cell. For instance, a cell that is located closer to a clock trunk may see a particular high signal slightly sooner than a neighboring cell that is located farther from the clock trunk. This occurrence is called “skew,” and it is often undesirable. For example, if enough skew occurs in a design, it may cause a signal that is intended to be read at the same clock cycle as another signal to be read in the following clock cycle, which may cause errors in output or may cause a system (in which the circuit is employed) to function improperly. Designs which place some or all sequential cells closer to a clock trunk may experience less skew from one sequential cell to the next, and may, therefore, eliminate such errors.

During the design process of a circuit, issues, such as skew and interference, may often be addressed in order to make the circuit operate as desired. In this example embodiment, during the design process, clock trunk 204 is routed in power/ground rail 207 in order to shield it from interference. Further, region 202 is automatically generated by region generation engine 110 (of FIG. 1) in the area immediately surrounding clock trunk 204. As explained further below, the placement of region 202 helps to reduce skew.

In the circuit design process, a region is an area (usually rectangular) that defines where certain cells are to be placed. In this example embodiment, cells 206 are the particular cells which receive the clock signal, and region 202 defines where such cells are to be placed by automatic cell placer 102 (of FIG. 1). Thus, region 202 is referred to as a “clock region.” In this example, region generation engine 101 (FIG. 1) automatically creates clock region 202 inside block 201 to surround at least a portion of clock trunk 204 that is in block 201. Clock region 202 is sized such that the sequential elements therein experience low levels of skew. For example, drawing the boundaries of the region as close to the clock trunk as possible may help to reduce skew by limiting the maximum amount of distance between the clock trunk and the cells. In some embodiments, though clock region 202 is created automatically, a circuit designer may be able to manually adjust the dimensions in order to refine the design appropriately.

The automatic creation of clock region 202 may serve to save time during the design process. For example, in traditional systems, circuit designers often placed clock trunks and clock signals by hand, and as a result, had to account for skew. By contrast, a circuit designer who uses a tool, such as system 100 (FIG. 1), operable to produce design 200, may be saved much time because region 202 is created and sized to minimize skew, thereby eliminating much of the burden on the designer to consider skew.

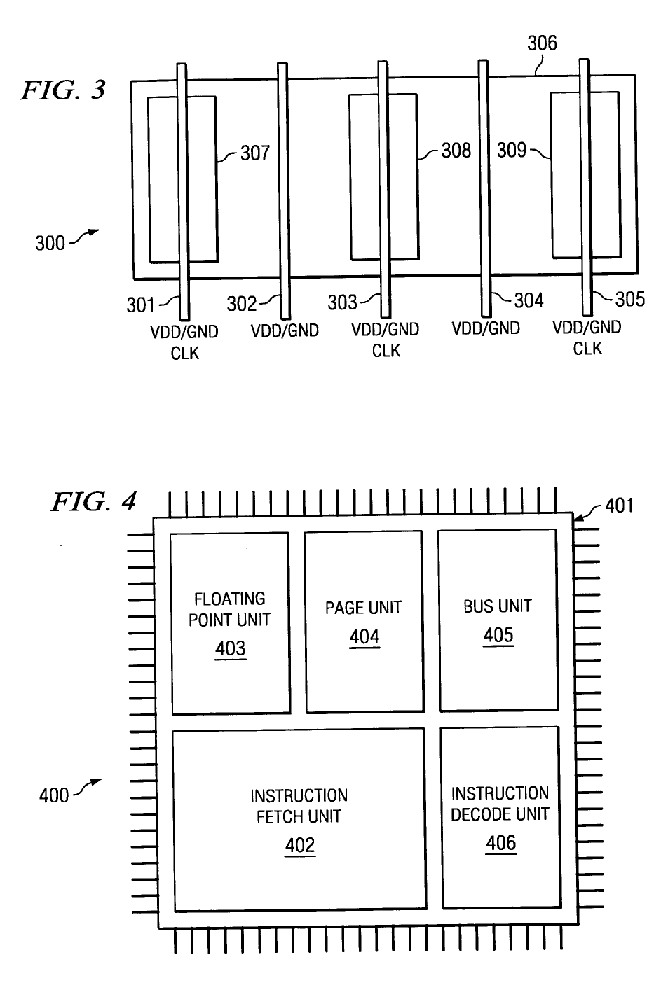

As mentioned above, design 200 may be part of a larger circuit design. FIG. 3 illustrates design 300, adapted according to various embodiments, for routing clock signals in a block. Once again, system 300 may be part of a design for a circuit, and it may be produced by a circuit design tool, such as system 100 (FIG. 1). System 300 includes power/ground rails 301-305, automatically created clock regions 307-309, and block 306.

In many embodiments, power/ground rails, such as rails 301-305, may be routed periodically, such that the distance between each rail 301-305 is nearly uniform. Such an arrangement may make circuit design more predictable because the distance between rails and the location of the rails may be known at a very early stage of the design process.

In the embodiment depicted in FIG. 3, out of the five power/ground rails in block 306, only three (301, 303, and 305) host a clock trunk because such spacing between regions 307-309 may be appropriate for the particular design. An appropriate number of clock trunks is often determined by the number of sequential cells in the block, the shape of the block, and the distance between the sequential cells and their corresponding clock trunks. In fact, in many designs, clock trunks may be routed in one of every two, one of every three, or one of every four power/ground rails. Any number of clock trunks that adequately provides clock signals is within the scope of embodiments.

In some designs, power/ground rails 301, 303, and 305 may be used to route clock trunks from one clock domain, while rails 302 and 304 may be used to route clock trunks of another clock domain. For example, it is a feature of some embodiments for a block to require two clock domains, such as clock and inverse clock, and to route a trunk for each domain in alternating power/ground rails. Any number and pattern of clock trunks, clock domains, and power/ground rails that adequately serve to provide clock signals and power are within the scope of embodiments.

The embodiments depicted in FIGS. 2 and 3 may be part of a larger microprocessor design. FIG. 4 is an illustration of top block-level design 400 for microprocessor 401, according to various embodiments. Items 402-406 are various logical units that may be included in a microprocessor design, and each may be considered to be a block. In this particular example, the units are the first level below the global level because they represent divisions of the chip as a whole. As mentioned above, other designs may further divide blocks at decreasing levels, and those designs are within the scope of various embodiments. For simplicity, power/ground rails and clock trunks are not shown in FIG. 4; however, it should be noted that each of blocks 402-406 may include many power/ground rails and many clocks trunks routed inside of those power/ground rails, as illustrated in FIGS. 2 and 3.

Referring back to FIG. 2, clock signal wires 208 are routed to each latch 206 in region 202 from clock trunk 204. In this embodiment, the particular design tool being used employs special cost functions to route clock wires 208 to latches 206. In many embodiments, the design tool assigns costs to each routing layer in the design (e.g., metal 1, metal2, metal3, etc. may be names of layers used to accommodate clock wire 208). The costs are not monetary costs, but rather, are logical costs used to quantify the relative desirability of a particular layer for use. In this example, a higher cost makes a particular layer less desirable for hosting one or more clock wires 208. The cost is generally based on physical properties of the layer, such as resistance. So, for example, a metal 1 layer may have much higher resistance than a metal3 layer, so the cost for using metal 1 is set much higher in order to discourage using the high-resistance layer if space in a lower-resistance layer is available. Thus, the router prefers to use metal3 over metal 1 when it automatically routes wires 208. Further, changing layers in a particular route increases resistance in the path, and therefore, “layer hopping” may be assigned a cost in order to avoid it as much as possible. The effect is that a designer may use the design tool to route wires 208 in an efficient manner because the designer does not have to manually calculate wire resistances and because low-resistance paths are determined automatically.

In many embodiments, a designer has the ability to manually adjust the costs up or down for any layer or layer change. Accordingly, a designer using such an embodiment may “tweak” the costs in an effort to force the design tool to route wires 208 on one or more layers, while possibly avoiding other layers or layer changes. This may allow the designer to optimize the circuit design according to a variety of factors, such as skew, manufacturing cost, and placement of other wires.

In many embodiments, special cost functions may be adjusted to cause the design tool to route clock signal wires 208 to sequential cells 206 in a relatively short, straight path with a minimum of layer changing. In an example embodiment, a designer adjusts the special cost functions to make via layers (which are used to change from one routing layer to another) very expensive in order to limit layer hopping. The designer may also make layers higher than the clock trunk layer more expensive than layers below the clock trunk layer so that the router will prefer to go down layers when it must change. These costs may be combined with an exponential rise in cost as the path goes down through layers. Such a cost may make the router prefer to stay up on the clock trunk layer as long as possible before changing to the next layer down and to stay close to the clock trunk layer when layer changing is required. This cost function scheme may be desirable in many embodiments because higher layers usually have less resistance than lower layers in a circuit design. (Although, in this example, the special cost functions cause a router to prefer to go down from the clock trunk layer, rather than up, such a scheme may be desirable when a via would add more resistance to a path than is saved by using the next layer up.)

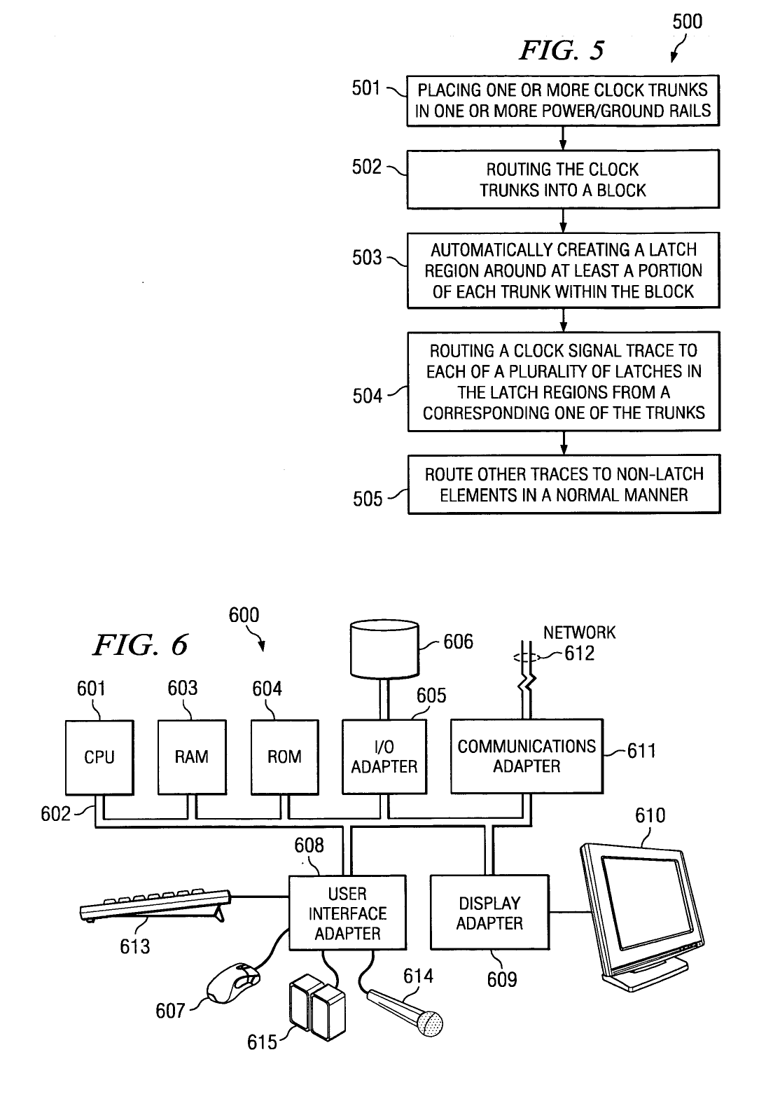

FIG. 5 is a flowchart depicting method 500 for routing clock signals in a block in a circuit design. Method 500 may be performed by a circuit design tool, which includes system 100 (FIG. 1), implemented as a computer program. In some embodiments, various parts of method 500 may be performed manually or with the assistance of such a software-implemented design tool. All such approaches are within the scope of embodiments. In part 501, one or more clock trunks are placed in one or more power/ground rails. The operation of part 501 may be performed at any time during the design process, but is usually performed before non-clock signal routing is accomplished. The number and spacing of the clock trunks may be determined by a variety of factors, such as shape of the block, number of sequential cells inside the block, and distance between the sequential cells and the clock trunk, among others. The number and spacing of clock trunks may be determined such that there is a minimum of distance between the sequential cells and the clock trunks. A clock trunk may be routed in every power/ground rail that services a particular block, or alternatively, one or more power/ground rails may be skipped in a regular or irregular fashion. Further, the clock trunks may be part of single clock domain, or the clock trunks may be part of a plurality of clock domains.

In part 502, the clock trunks are routed into a block. The clock trunks may be routed all the way through the block (as in FIG. 3), or may be routed only partially through the block (as in FIG. 2). Because the power/ground rails may also be routed all the way through or part of the way through the block, part 502 may be performed during part 501.

In part 503, a cell region around at least a portion of each trunk within the block is created automatically. In other words, for each clock trunk, a cell region is created around at least a portion of the trunk. As explained above, the cell regions define an area for placement of sequential cell elements that are in communication with clock signals from the clock trunk. Such cells may include, for instance, latches. The cell regions may surround the entire lengths of the trunks that are within the block, or they may only surround a portion of the trunk that is within the block, as in FIGS. 2 and 3. All such approaches are within the scope of embodiments. When the design tool creates the cell region, it may account for skew, availability of space, number of latches needed, or similar factors that may affect the circuit design. While the design tool creates the cell region automatically, some embodiments may allow a designer to modify the cell region according to design needs. For example, if a designer knows that a certain additional amount of skew is acceptable in the cell region of the block, he may modify the region to be larger.

In part 504, a clock signal wire is routed to each of a plurality of cells in the cell regions from a corresponding one of the trunks. In this example, a clock wire is routed to each cell from the clock trunk that is within the same cell region as the particular cell. In some embodiments, a design tool may employ special cost functions to determine the path that a particular wire takes through the various layers. In some embodiments, the special cost functions may be preprogrammed into a database in the design tool such that little or no intervention from a designer is required. Additionally, in some embodiments, a designer may adjust some of the special cost functions to further determine the path that the wire may take according to design needs. In other embodiments, a designer may route many of the wires manually, rather than automatically by the design tool.

Once the clock signals in the block are routed, a designer may then route wires to other non-clock cells in a normal manner, as in part 505. The routing may include, for example, routing data signals to combinational logic gates. A normal manner may mean, for instance, that the special cost functions are turned off, such that the restrictions placed on routing the non-clock signals may be much more lenient. Alternate approaches may employ other, less restrictive cost functions or may use another method entirely, and all are within the scope of embodiments.

An advantage of some embodiments that utilize method 500 is that when the clock trunks and clock signal wires are routed at a particular level, clock signals may be routed at a higher level independently of the method used at the lower level. For instance, while at a lower block level, method 500 may be performed to route clock signals, at the top block level a designer may utilize a Clock Tree Synthesis (CTS) approach. CTS is a fully-automated approach that may be used to place and route clock signals, but which gives a designer very little control and may not optimize skew levels and clock shielding the way that method 500 allows. At the top block level, wherein clock trunk routing usually includes simply routing trunks between blocks, it may be useful to use an automatic CTS engine, and method 500 of FIG. 5, in many embodiments, will not affect the availability of that useful tool at such higher levels.

An advantage of method 500 is that it may provide speed to an otherwise tedious process. In traditional systems, designers often routed the clock trunks and clock signal wires manually because of the precision demanded in clock signals by the very nature of IC designs. The creation of the sequential cell regions and the use of special cost functions allows a level of automation to be introduced to the process while still keeping levels of skew and interference below minimum requirements. Method 500 may function to save designers from much of the tedium associated with routing clock signals, and to save time during the design process.

When implemented via computer-executable instructions, various elements of embodiments are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information.

FIG. 6 illustrates an example computer system 600 adapted according to various embodiments. That is, computer system 600 comprises an example system on which various embodiments may be implemented. Central processing unit (CPU) 601 is coupled to system bus 602. CPU 601 may be any general purpose CPU, and the embodiments are not restricted by the architecture of CPU 601 as long as CPU 601 supports the inventive operations as described herein. CPU 601 may execute the various logical instructions according to embodiments. For example, CPU 601 may execute machine-level instructions according to the exemplary operational flows described above in conjunction with FIG. 5 or may execute instructions to produce circuit designs, such as may include design 200 of FIG. 2 or design 300 of FIG. 3.

Computer system 600 also may include random access memory (RAM) 603, which may be SRAM, DRAM, SDRAM, or the like. Computer system 600 may include read-only memory (ROM) 604 which may be PROM, EPROM, EEPROM, or the like. RAM 603 and ROM 604 hold user and system data and programs, as is well known in the art.

Computer system 600 also may include input/output (I/O) adapter 605, communications adapter 611, user interface adapter 608, and display adapter 609. I/O adapter 605, user interface adapter 608, and/or communications adapter 611 may, in certain embodiments, enable a user to interact with computer system 600 in order to input information, such as adjustments to special cost functions or instructions to route clock trunks in certain power/ground rails.

I/O adapter 605 may connect to storage device(s) 606, such as one or more of hard drive, compact disc (CD) drive, floppy disk drive, tape drive, etc. to computer system 600. The storage devices may be utilized when RAM 603 is insufficient for the memory requirements associated with storing data for a chip design or part of a chip design. Communications adapter 611 is adapted to couple computer system 600 to network 612. User interface adapter 608 couples user input devices, such as keyboard 613, pointing device 607, and microphone 614 and/or output devices, such as speaker(s) 615 to computer system 600. Display adapter 609 is driven by CPU 601 to control the display on display device 610 to, for example, display a user interface associated with design tools of various embodiments.

It shall be appreciated that the embodiments are not limited to the architecture of system 600. For example, any suitable processor-based device may be utilized, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may utilize any number of suitable structures capable of executing logical operations according to various embodiments.

What is claimed is:

1. A system comprising:
a region generation engine operable to create a region automatically around a portion of a clock trunk in a block, wherein the region defines an area for placement of selected cells;
an automatic cell placer operable to place the cells in the region; and
a routing engine operable to route signal wires from the clock trunk to the cells automatically according to one or more functions.

2. The system of claim 1 wherein the cells are selected to be in communication with a clock signal from the clock trunk.

3. The system of claim 2 wherein the cells comprise level-sensitive latches.

4. The system of claim 1 wherein the functions are special cost functions, which define a desirability of a particular path for any one of the signal wires.

5. The system of claim 1 wherein one or more of the functions may be adjusted by a designer to optimize a circuit design.

6. The system of claim 1 wherein the region is sized in order to minimize skew with respect to the cells.

7. The system of claim 1 wherein the region generation engine, the automatic cell placer, and the routing engine are part of larger circuit design tool.

8. A method comprising:
placing each of one or more clock trunks in one or more power/ground rails;
routing the clock trunks into a block;
automatically creating a cell region around at least a portion of each trunk within the block.

9. The method of claim 8 further comprising routing a clock signal wire to each of a plurality of latches in the cell regions from a corresponding one of the trunks.

10. The method of claim 9 wherein routing at least one clock signal comprises adjusting special cost functions to quantify relative desirabilities of certain path segments for routing the clock signal wires.

11. The method of claim 8 further comprising routing wires to non-latch cells in a normal manner.

12. The method of claim 11, wherein the normal manner does not employ special cost functions.

13. The method of claim 8 wherein placing each of one or more clock trunks in one or more power/ground rails comprises:
automatically determining an appropriate number of clock trunks; and
automatically determining locations for the clock trunks.

14. The method of claim 13, wherein automatically determining an appropriate number of clock trunks comprises considering a shape of the block and a number of sequential cells.

15. A system comprising:
means for routing a clock trunk into a block between a power/ground rail;
means for automatically creating a cell region immediately surrounding a portion of the trunk in the block;
means for placing one or more sequential cells in the cell region; and
means for routing one or more clock signals to the sequential cells from the trunk.

16. The system of claim 15 wherein the means for routing the clock trunk comprise means for dynamically adjusting a special cost function.

17. The system of claim 15 further comprising means for employing clock tree synthesis in a global-level design.

18. The system of claim 15 wherein the means for automatically creating a cell region comprises means for creating the cell region according to a size of the block and a number of the sequential cells.

19. The system of claim 15 wherein the means for routing a clock trunk, the means for automatically creating a cell region, the means for placing one or more sequential cells in the cell region, and the means for routing one or more clock signals are included in a larger circuit design tool.

20. The system of claim 19 wherein the larger circuit design tool is adapted to be used to design microprocessors.

21. The method of claim 15, wherein the sequential cells comprise latches.

22. A system comprising:
a circuit design, which includes:
a clock trunk;
a power/ground rail;
a block, wherein the clock trunk runs inside the power ground rail and is routed into the block; and
a sequential cell region, wherein the sequential cell region is automatically created inside the block to surround at least a portion of the clock trunk that is in the block.

23. The system of claim 22 further comprising a plurality of sequential cells in the sequential cell region, wherein each sequential cell is in communication with a signal from the clock trunk.

24. The system of claim 23 wherein the signal from the clock trunk is routed to the sequential cells using special cost functions.

25. The system of claim 24 wherein the special cost functions define logical costs that determine a desirability of a path for routing the signal.

26. The system of claim 22 wherein the circuit design is part of a microprocessor design.
